(19) United States
(12) Patent Application Publication
(10) Pub. No.: US 2003/0041700 A1
(43) Pub. Date: Mar. 6, 2003

(54) Close end wrench

(76) Inventor: Ander Chen, Chang-Hua Hsien (TW)

Correspondence Address: CHARLES E. BAXLEY, ESQUIRE, Hart, Baxley, Daniels & Holton, 5th Fl., 59 John St., New York, NY, 10038, US

(21) Appl. No.: 09/943,316

(22) Filed: Aug. 31, 2001

(51) Int. Cl. B25B 13/00

(52) U.S. Cl. 81/125.1

(57) ABSTRACT

A close end wrench includes a shank and a close end in which an elongated hole is defined therethrough. A symmetric axis “S” passes through a middle position of the close end and intersects at a first point S1 and a second point S2 of an inner periphery of the elongated hole. A first inner surface and a second inner surface in the inner periphery of the elongated hole are formed and separated by the symmetric axis “S”. A first recess surface defined in the first inner surface and starts from the first point S1. A convex is connected to the first recess surface and a first protrusion surface is connected to the convex. A second recess surface is connected to the first protrusion surface and a second protrusion surface is connected to the second recess surface. The second protrusion surface is ended at the second point S2. The second inner surface is shaped as a mirror image of the first inner surface about the symmetric axis “S”. A nut can be movably engaged between the first and the second inner surface.

### FIELD OF THE INVENTION

The present invention relates to a close end wrench which has an elongate hole for the nut being movable therein and clamped in two end positions of the hole.

### BACKGROUND OF THE INVENTION

A conventional close end wrench 10 is shown in FIG. 1 and generally includes ring-shaped close end 12 and a plurality of protrusions 120 extend radially inward from an inner periphery of the close end 12. A nut or a bolt head is then engaged with the protrusions 120 and the recesses defined between the protrusions 120. However, the close end of the wrench has to be removed from the object and re-mounted to the object when rotating. In other words, this type of wrench 10 cannot be rotated reciprocatingly as the way of operation of a ratchet tool. This costs a lot of time to loosen or tight the object.

### SUMMARY OF THE INVENTION

In accordance with one aspect of the present invention, there is provided a close end wrench which comprises a shank and a close end having an elongated hole defined therethrough and a symmetric axis “S” passes through a middle position of the close end and intersects a first point S1 and a second point S2 of an inner periphery of the elongated hole. A first inner surface and a second inner surface in the inner periphery of the elongated hole are formed and separated by the symmetric axis “S”. A first recess surface is defined in the first inner surface of the elongated hole and starts from the first point S1. A convex is connected to the first recess surface and a first protrusion surface is connected to the convex. A second recess surface is connected to the first protrusion surface and a second protrusion surface is connected to the second recess surface. The second protrusion surface is ended at the second point S2. The second inner surface is shaped as an mirror image of the first inner surface about the symmetric axis “S”.

The primary object of the present invention is to provide a close end of a wrench wherein the close end can be rotated while the nut is remained in the close end.

The other object of the present invention is to provide a close end of a wrench wherein the nut can be movably retained in the close end and clamped at two inner most positions in the close end.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional wrench with a close end;

FIG. 2 is a perspective view to show a wrench having a close end of the present invention;

FIG. 3 is a plan view to show the close end of the present invention;

FIG. 4 is a plan view to show a nut is retained in a first inner most position in the close end of the present invention, and

FIG. 5 is a plan view to show a nut is retained in a second inner most position in the close end of the present invention.

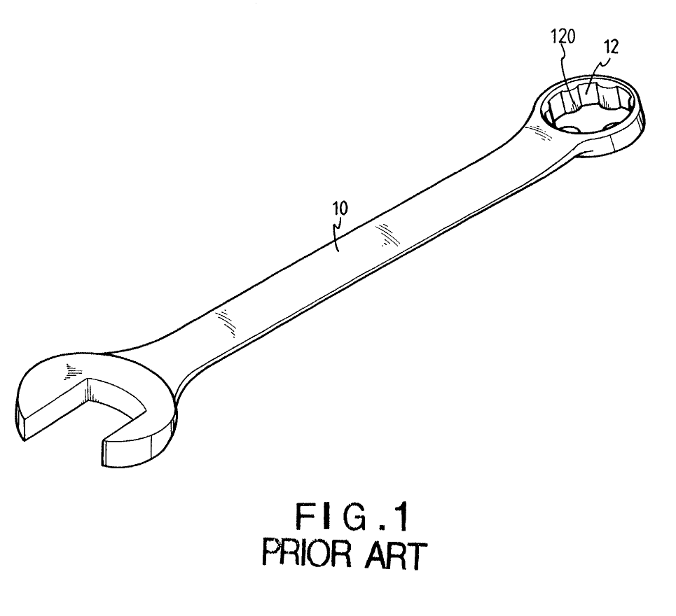

### DETAILED DESCRIPTION OF THE PREFERRED EMBODIMENT

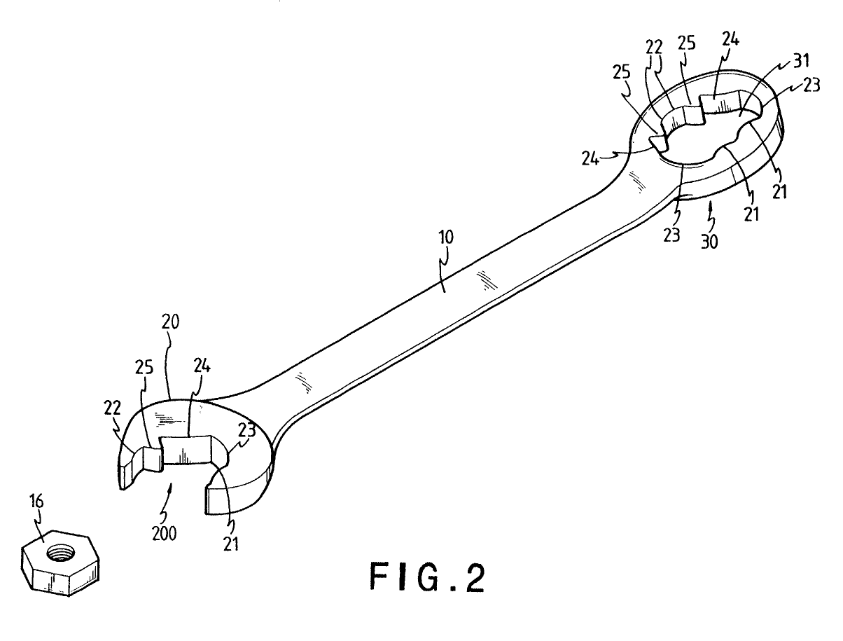

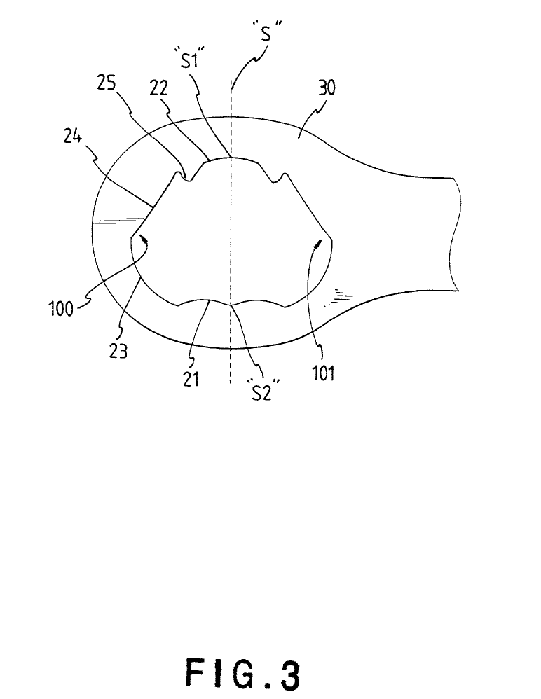

Referring to FIGS. 2 and 3, the wrench of the present invention comprises a shank 10 and a close end 30 and an open end 20 respectively connected to two ends of the shank 10. An elongated hole is defined through the close end 30 and a symmetric axis “S” passes through a middle position of the close end 30. The symmetric axis “S” intersects at a first point S1 and a second point S2 of an inner periphery of the elongated hole. A first inner surface 100 and a second inner surface 101 in the inner periphery of the elongated hole are formed and separated by the symmetric axis “S”.

A first recess surface 22 IS defined in the first inner surface of the elongated hole and starts from the first point S1. A convex 25 is connected to the first recess surface 22 and a first protrusion surface 24 is connected to the convex 25. A second recess surface 23 is connected to the first protrusion surface 24 and a second protrusion surface 21 is connected to the second recess surface 23. The second protrusion surface 21 is ended at the second point S2. The second inner surface 101 is shaped as an mirror image of the first inner surface about the symmetric axis “S”.

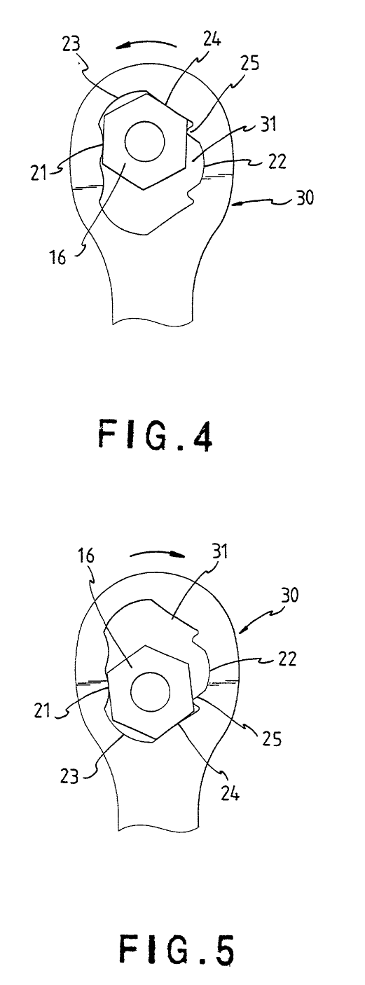

As shown in FIGS. 4 and 5, a hexagonal nut 16 is retained in the elongated hole of the close end 30 and one side of the nut 16 is engaged with the first protrusion surface 24, another side adjacent the side engaged with the first protrusion surface 24 contacts the convex 25, and yet another side contacts the second protrusion surface 21. By the engagement, the nut 16 can be clamped in the first inner surface 100 and the second inner surface 101. When moving the close end 30 to allow the nut 16 in the center of the elongated hole, the close end can be rotated while the nut is not rotated. By this close end 30, the close end does not remove from the nut 16 to rotate an angle so that the job for loosening or tightening the nut 16 is conveniently.

The open end 20 has an engaging recess 200 and the inner periphery of the engaging recess 200 is shaped as the first inner surface 100 or the second inner surface 101 in the inner periphery of the close end 30. The nut 16 is clamped by the 10. first protrusion surface 24, the convex 25 and the second protrusion surface 21. When the open end 20 is slightly move away from the nut 16, the open end 20 is freely rotated while the nut 16 is remained still.

While we have shown and described the embodiment in accordance with the present invention, it should be clear to those skilled in the art that further embodiments may be made without departing from the scope of the present invention.

What is claimed is:

1. A close end wrench comprising:
a shank and a close end connected to an end of said shank, an elongated hole defined through said close end and a symmetric axis “S” passing through a middle position of said close end, said symmetric axis “S” intersecting at a first point S1 and a second point S2 of an inner periphery of said elongated hole, a first inner surface and a second inner surface in said inner periphery of said elongated hole being formed and separated by said symmetric axis “S”;
a first recess surface defined in said first inner surface of said elongated hole and starting from said first point S1, a convex connected to said first recess surface and a first protrusion surface connected to said convex, a second recess surface connected to said first protrusion surface and a second protrusion surface connected to said second recess surface, said second protrusion surface ended at said second point S2, and
said second inner surface being shaped as an mirror image of said first inner surface about said symmetric axis “S”.
